(19) United States
(12) Patent Application Publication
(10) Pub. No.: US 2003/0113002 A1
(43) Pub. Date: Jun. 19, 2003

(54) Identification of people using video and audio eigen features

(75) Inventors: Vasanth Philomin, Hopewell Junction, NY (US); Srinivas Gutta, Yorktown Heights, NY (US); Miroslav Trajkovic, Ossining, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/023,138

(22) Filed: Dec. 18, 2001

(51) Int. Cl. G06K 9/00

(52) U.S. Cl. 382/116

(57) ABSTRACT

A method and system for concatenating eigenvoice vector data with eigenface vector data to obtain a new basic eigenvector to more positively and accurately identify a person. More specifically, for a specific person, the data of an eigenface vector is concatenated with the data of an eigenvoice vector to form a single vector, and this single vector is compared to reference vectors also obtained by concatenting the data of eigenface vectors and eigenvoice vectors to obtain a single vector of each persons in a defined group of people to determine if a person that is a member of a defined group of people. Using this single eiginvector gives a higher success rate for identifying a person than an eigenface vector or an eigenvoice vector used separately or together as separate vectors.

### BACKGROUND OF THE INVENTION

1. Field of the Invention

The present invention relates generally to person recognition and more particularly to method and apparatus for using video information in combination with audio information to accurately identify a person.

2. Description of the Related Art

Person identification systems that utilize a video learning system may encode an observed image of a person into a digital representation which is then analyzed and compared with a stored model for further identification or classification. Video identification of individuals is currently being used to detect and/or identify faces for various purposes such as law enforcement, security, etc.

An image of the person to be identified is normally in a video or image format and is obtained by using a video or still camera. The analysis of the obtained image requires techniques of pattern recognition that are capable of systematically identifying the patterns of interest within a relatively large set of data. Some of the most successful techniques are statistical in nature. To perform the required pattern recognition process on raw data of an individual that is digitally represented as grids of picture element points, also referred to as pixels, is considered to be computationally prohibitive. Therefore, what is normally done is to transfer the data into a systematic representation that is appropriate for the analysis to be performed. One technique of processing the data into a form that is more analysis friendly is the Karhunen-Loeve transformation. This technique involves an eigenvalue and eigenvector analysis of the covariance matrix of the data to provide a representation which can be more easily processed by statistical analysis. (See, for example, Kirby et al., 12 IEEE Transactions of Pattern Analysis and Machine Intelligence 103 (1990)). More specifically, objects may be represented within a very large coordinate space in which, by correlating each pixel of the object to a spatial dimension, the objects will correspond to vectors, or points, in that space. In accordance with the Karhunen-Loeve transformation, a working set or ensemble of images of the entity under study is subjected to mathematical transformations that represent the working images as eigenvectors of the ensemble's covariance matrix. Each of the original working images can be represented exactly as a weighted sum of the eigenvectors.

Such eigenspace decompositions are potentially more powerful in the art of data processing than standard detection techniques such as template matching or normalized correlation. To analyze the data efficiently, it should be partitioned so that the search can be restricted to the most salient regions of the data space. One way of identifying such regions is to recognize that the distribution of objects within the multidimensional image space tends to be grouped within a characteristic region, and utilize the principal components of the eigenvectors to define this region. The eigenvectors each account for a different amount of variation among the working set of images, and can be thought of as a set of features which together characterize the modes of variation among the images. Each vector corresponds to an object image and contributes more or less to each eigenvector. Each object image can be approximately represented by linear combinations of the best or principal component eigenvectors which are those with the largest eigenvalues and which are associated with the most variance within the set of working images.

In one instance, eigenspace decompositions are used in a face recognition system wherein the principal components define a principal subspace or face space region of a high dimension image space in which the working images cluster. Input images are scanned to detect the presence of faces by mathematically projecting the images onto face space. The distance of an input image which is represented as a point in the high dimensional image space from face space is utilized to discriminate between face and non-face images. Stated differently, if the computed distance falls below a preselected threshold, the input image is likely to be a face.

Other systems in the art relate to person identification by using speech recognition systems. Speech recognition systems are used for speaker verification or speaker identification purposes. Speaker verification involves determining whether a given voice belongs to a certain speaker. Speaker identification involves matching a given voice to one of a set of known voices. One method of using speech to identify a person uses models that are constructed and trained using the speech of known speakers. The speaker models typically employ a multiplicity of parameters which are not used directly, but are concatenated to form supervectors. The supervectors, each being assigned to only one speaker, contain all of the training data for the entire speaker population.

By means of a linear transformation, the supervectors are dimensionally reduced which results in a low dimensional space which is referred to as eigenspace, and the vectors of eigenspace are referred to as eigenvoice vectors. Further dimension reduction of the eigenspace can be obtained by discarding some of the eigenvector terms. Thereafter, each speaker of the training data is represented in eigenspace as a point or as a probability distribution. The first is somewhat less accurate as it treats the speech from each speaker as being substantially constant. The second is aware that the speech of each speaker does vary somewhat during each conversation.

New speech data is obtained and used to construct a supervector that is then dimensionally reduced and represented in the eigenspace. When representing speakers as points in eigenspace, a simple geometric distance calculation can be used to identify which training data speaker is closest to the new speaker. Proximity is assessed by treating the new speaker data as an observation and by then testing each distribution candidate (representing the training speakers) to determine what is the probability that the candidate generated the observation data. The candidate with the highest probability is assessed as having the closest proximity. In some high-security applications it may be desirable to reject verification if the most probable candidate has a probability score below a predetermined threshold. A cost function may be used to thus rule out candidates that lack a high degree of certainty. Assessing the proximity of the new speaker to the training speakers may be carried out entirely within eigenspace. The new speech from the speaker is verified if its corresponding point or distribution within eigenspace is within a threshold proximity to the training data for that speaker.

It is noted in the prior art that a number of advantages are obtained by assessing the proximity between the new speech data and the training data in eigenspace. For example, eigenspace represents in a concise, low dimensional way every aspect of each speaker, not just a selected few features of each speaker. Proximity computations performed in eigenspace can be made quite rapidly as there are typically substantially fewer dimensions to contend with in eigenspace than there are in the original speaker model space or feature vector space. Additionally, a processing system based on proximity computations performed in eigenspace does not require that the new speech data include each and every example or utterance that was used to construct the original training data.

There are a number of works in the area of model based video coding and model based audio coding. For example, U.S. Pat. No. 5,164,992, and a paper by Turk and Pentland, “Eigenfaces for Recognition”, Journal of Cognitive Neuroscience, Vol. 3, No. 1, pp. 71-86, relate to obtaining and using eigenface vectors to identify a video image of a person. U.S. Pat. No. 5,710,833 is directed toward generating parameters for obtaining eigenface vectors. U.S. Pat. No. 6,141,644 is directed toward the verification and identification of a person by using eigenvoice vectors.

Thus, the prior art discloses the use of eigenvectors, which are referred to as eigenfaces to identify video images of people. The prior art also discloses the use of eigenvectors, which are referred to as eigenvoice when used to identify people by their voice signature. It is reasonable to assume that each method discussed above for identifying a person has a success rate that is less than perfect and that a method that will provide a higher person identification success rate is not only desired, but is needed.

### SUMMARY OF THE INVENTION

The method and apparatus of the present invention is directed to concatenating eigenvoice vector data with eigenface vector data to obtain a new composite eigenvector to more positively and accurately identify a person. More specifically, for a specific person, the data of an eigenface vector is concatenated with the data of an eigenvoice vector to form a single vector, and this single vector is compared to reference vectors, also obtained by concatenating the data of eigenface vectors and eigenvoice vectors, of persons in a defined group of people to determine if a specific person is a member of a defined group of people. Using this single composite eigenvector gives a higher success rate for identifying a person than an eigenface vector or an eigenvoice vector used separately or together as separate vectors.

### BRIEF DESCRIPTION OF THE DRAWINGS

The foregoing discussion will be understood more readily from the following detailed description of the invention, when taken in conjunction with the accompanying drawings, in which:

FIG. 1 schematically illustrates a representative hardware environment for the present invention;

FIG. 2 is a flow chart depicting operation of the subsystem for obtaining eigenface vectors;

FIG. 3 is a flow chart depicting operation of the subsystem for obtaining eigenvoice vectors;

FIG. 4 is a flow chart depicting operation of a subsystem for comparing reference eigenvectors of people in a defined group of people with the eigenvector of an unknown person to determine if the unknown person is a member of the defined group; and

FIG. 5 is a block diagram of a system in accordance with the principles of the invention.

### DETAILED DESCRIPTION OF THE PRESENTLY PREFERRED EMBODIMENTS

In the practice of the present invention, it is to be understood that any method or system that generates eigenface vectors can be used for identifying a person from a video image. In a similar manner, any method or system that generates eigenvoice vectors can be used for identifying or verifying the identity of a person from audio information. In the present invention, the face feature data and voice feature data for any one person are concatenated to form a composite eigenvector, and this composite eigenvector is used for person identification and/or person verification. In the present invention, data for the two discrete eigen vectors, the eigenface vector and the eigenvoice vector, for each person are concatenated to generate a single composite eigenvector which is used to identify a person.

Various video and audio features can be used to obtain data for eigenface and eigenvoice vectors. Referring to eigenface vector data, there can be an input where the image is in color with red, green and blue values for each pixel. The face can be detected using one of many known algorithms to compute the values r+g+b, r/(r+g+b) and g/(r+g+b) of the face region. These three values can be calculated for each pixel in the region of interest and several features can be created from these values. For example, the block average of these values can be computed in blocks of the image with predetermined sizes to have robustness to changing conditions, or these values can be used as they are pixel by pixel. In this example, the r+g+b is the luminance value and the other two are chrominance values. Referring now to eigenvoice vector data, mel-frequency cepstral coefficients are the most common audio features used. These can be calculated using the DCT of filter-banked FFT spectra. See the reference: A. M. Noll, Cepstrum Pitch Determination, Journal of Acoust. Soc. Of America, 41 (2), 1967. For linear prediction coefficients, see reference: R. P. Ramachandran et al., A Comparative Study Of Robust Linear Predictive Analysis Methods With Applications To Speaker Identification. IEEE Trans. Audio processing 3 (2), 117-125, 1995.

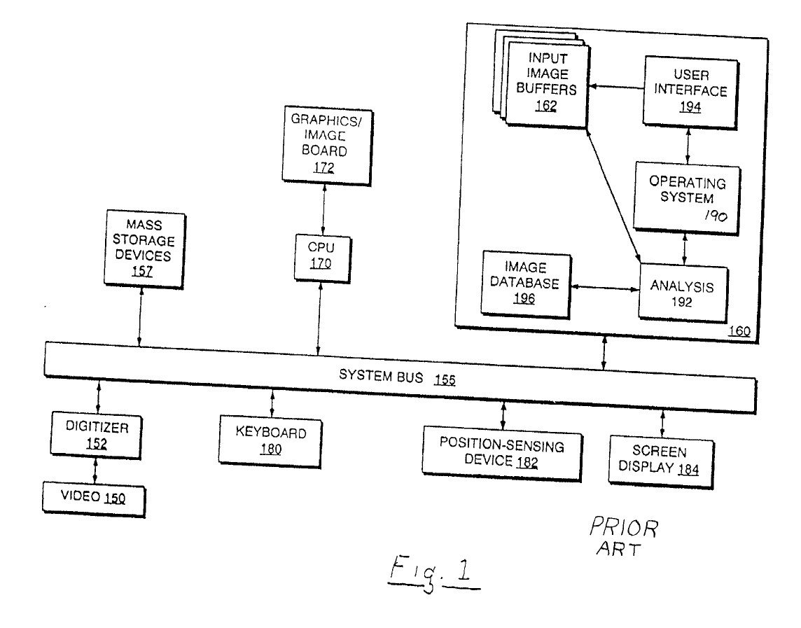

As noted above, a system that utilizes eigenface vectors is disclosed in U.S. Pat. No. 5,710,833, the disclosure of which is incorporated herein by reference. This technology will now be summarized. Referring to prior art FIG. 1, a video source 150 (e.g., a charge-coupled device or “CCD” camera), supplies an input image to be analyzed. A still output of video source 150 is digitized as a frame into a pixel map by a digitizer 152. The digitized video frames are sent as bit streams on a system bus 155, over which all system components communicate, and may be stored in a mass storage device or memory (such as a hard disk or optical storage unit) 157 as well as in a series of identically sized input image buffers which form a portion of a system memory assemblage 160.

The operation of the illustrated system is directed by a central-processing unit (“CPU”) 170. To facilitate rapid execution of the image-processing operations hereinafter described, the system preferably contains a graphics or image-processing board 172, which is a standard component well-known to those skilled in the art. The user interacts with the system using a keyboard 180 and a position-sensing device (e.g., a mouse) 182. The output of either device can be used to designate information or select particular areas of a screen display 184 to direct functions to be performed by the system.

A system memory assemblage 160 contains, in addition to an input buffers 162, a group of modules that control the operation of CPU 170 and its interaction with the other hardware components. An operating system module 190 directs the execution of low-level, basic system functions, such as memory allocation, file management and operation of mass storage devices 157. At a higher level, an analysis module 192, implemented as a series of stored instructions, directs execution of the primary functions. Instructions defining a user interface module 194 allows straightforward interaction over screen display 184. User interface module 194 generates words or graphical images on display 184 to prompt action by the user, and accepts user commands from keyboard 180 and/or position-sensing device 182. Finally, the system memory assemblage 160 includes an image database module 196 for storing an image of objects or features encoded as described above with respect to eigen templates stored in mass storage device 157.

The contents of each image buffer 162 defines a regular two-dimensional pattern of discrete pixel positions that collectively represent an image. The image may be used to drive (e.g., by means of image-processing board 172 or an image server) screen display 184 to display that image. The content of each memory location in a frame buffer directly governs the appearance of a corresponding pixel on display 184. Execution of the key tasks is directed by analysis module 192, which governs the operation of CPU 170, and controls its interaction with the module of the main memory assemblage 160 in performing the steps necessary to encode objects or features.

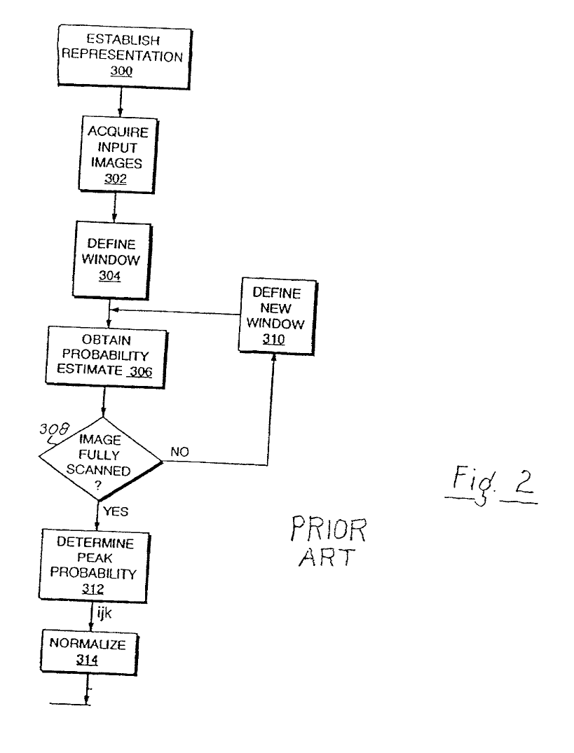

Referring to prior art FIG. 2, there is disclosed a flow chart for establishing reference eigenface vectors of persons that are members of a defined group of people. In training step 300, a coarse eigenvector face representation (e.g., a “face space”, composed of the 10 “eigenface” eigenvectors having the highest associated eigenvalues) and eigenvector representations of various facial features (e.g., eyes, nose and mouth) are established from a series of training images (preferably generated at a single viewing angle). In response to an appropriate user command, the input image is loaded into a first image buffer 162 (of FIG. 1) in step 302, making it available to analysis module 192 (of FIG. 1). The input image is then linearly scaled to a plurality of levels (e.g., ½×, ¼×, etc.), smaller than the input image, and each of the scaled images is stored in a different one of image buffers 162.

In step 304, a rectangular “window” region of each scaled input image (e.g., 20×30 pixels) is defined, ordinarily at a corner of the image. The pixels within the window are represented as vectors of points in image space and projected onto the principal subspace and the orthogonal subspace to obtain a probability estimate in step 306, in accordance with Equations 8 and 11 of U.S. Pat. No. 5,710,833, the disclosure of which is incorporated herein by reference. Unless the image has been fully scanned (step 308), the window is “moved” by defining a new region (step 310) of the same window size but displaced a distance of one pixel from the already-analyzed window. When an edge of the input image is reached, the window is moved perpendicularly by a distance of one pixel, and scanning resumes in the opposite direction. At the completion of image scanning, the window having the highest probability of containing a face is identified, pursuant to Equation 16 of U.S. Pat. No. 5,710,833 (step 312). Steps 304 to 312 are repeated for all scales, thereby generating multiscale saliency maps. Following analysis of all scaled images, the window having the highest associated probability estimate and its associated scale is identified and normalized for translation and scale (step 314). The training step 300 which is performed by a feature-extraction module and the normalizing step 314 are carried out by an object centered representation module.

A contrast-normalization module processes the centered, masked face to compensate for variations in the input imagery arising from global illumination changes and/or linear response characteristics of a particular CCD camera as these variations can affect both recognition and coding accuracy. The contrast normalization module normalizes the gray-scale range of the input image to a standard range (i.e., the range associated with the training images, which may themselves be normalized to a fixed standard by the contrast normalization module). The normalization coefficients employed in contrast adjustment may be stored in memory to permit later reconstruction of the image with the original contrast. Following contrast normalization, the obtained eigenface vectors are stored in the main system memory 160 (see prior art FIG. 1).

Having obtained the reference eigenface vectors of the faces of members of a defined group, an existing prior art process is used to obtain the eigenvoice vectors of the voices of members of the defined group for identification and/or verification. This can be done using the teachings of U.S. Pat. No. 6,141,644, the disclosure of which is incorporated herein by reference.

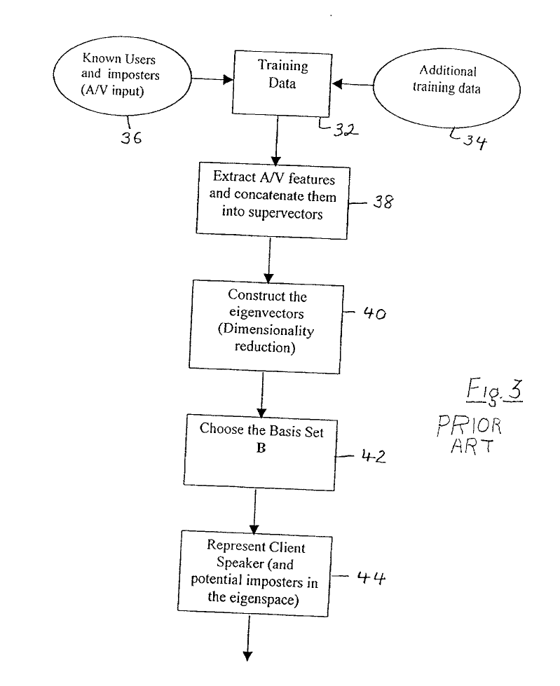

FIG. 3 is a flow chart depicting the prior art method for establishing reference eigenvoice vectors of the members of the defined group of people utilizing the teachings of the '644 patent. As a first step in performing speaker identification/speaker verification, an eigenspace is constructed. The specific eigenspace constructed depends upon the application. In the case of speaker identification, a set of known client speakers is used to supply training data 32 upon which the eigenspace is created. Alternatively, for speaker verification, the training data 32 are supplied from the members of the group or speakers 34 for which verification is desired and also from one or more potential impostors 36. Aside from this difference in training data source, the procedure for generating the eigenspace is essentially the same for both speaker identification and speaker verification applications.

The eigenspace for speaker identification is constructed by developing and training speaker models for each speaker. Those skilled in the art will note that any speech model having parameters suitable for concatenation may be used. Preferably, the models are trained with sufficient training data so that all sound units defined by the model are trained by at least one instance of actual speech for each speaker. Although not illustrated explicitly in prior art FIG. 3, the model training step can include appropriate auxiliary speaker adaptation processing to refine the models. Examples of such auxiliary processing include Maximum A Posteriori estimation or other transformation-based approaches such as Maximum Likelihood Linear Regression. The objectives in creating the speaker models is to accurately represent the training data corpus which is then used to define the metes and bounds of the eigenspace into which each training speaker is placed, and to which each new speech utterance is tested.

The models generated for each speaker are used to construct a voice supervector at step 38. The voice supervector may be formed by concatenating the parameters of the model for each speaker. Where Hidden Markov Models are used, the voice supervector for each speaker may comprise an ordered list of parameters (typically floating point numbers) corresponding to at least a portion of the parameters of the Hidden Markov Models for that speaker. Parameters corresponding to each sound unit are included in the voice supervector for a given speaker and may be organized in any convenient order. The order is not critical, however, once an order is adopted it must be followed for all training speakers.

The choice of model parameters to use in constructing the voice supervector will depend on the available processing power of the computer system. When using Hidden Markov Model parameters, voice supervectors may be constructed from the Gaussian means. If greater processing power is available, the voice supervectors may also include other parameters. If the Hidden Markov Models generate discrete outputs (as opposed to probability densities), then these output values may be used to comprise the voice supervector. After constructing the voice supervector, a dimensionality reduction operation is performed at step 40 by any linear transformation that reduces the original high-dimensional supervectors into voice basis vectors. A non-exhaustive list of examples of linear transformation includes: Principal Component Analysis (PCA), Independent Component Analysis (ICA), Linear Discriminant Analysis (LDA)), Factor Analysis (FA), and Singular Value Decomposition (SVD). The class of dimensionality reduction techniques which are useful is set forth in U.S. Pat. No. 6,141,644.

The vectors generated at step 40 define a voice eigenspace spanned by the eigenvectors. Dimensionality reduction yields one voice eigenvector for each one of the training speakers. Thus, if there are T training speakers, then the dimensionality reduction step 40 produces T voice eigenvectors. These voice eigenvectors define what is called eigenvoice space or eigenspace. The voice eigenvectors that make up the eigenvoice space each represent a different dimension across which different speakers may be differentiated. Each voice supervector in the original training set can be represented as a linear combination of these voice eigenvectors. The voice eigenvectors are ordered by their importance in modeling the data, where the first eigenvector is more important than the second, which is more important than the third, and so on.

Although a maximum number of voice eigenvectors is produced at step 40, in practice, it is possible to discard several of these eigenvectors, keeping only the first few voice eigenvectors. Thus, at step 42 there is optionally extracted a group B of the voice eigenvectors to comprise a reduced parameter voice eigenspace. The higher order voice eigenvectors can be discarded because they typically contain less important information with which to discriminate among speakers. Reducing the eigenvoice space to fewer than the total number of training speakers provides an inherent data compression that can be helpful when constructing practical systems with limited memory and processor resources.

After generating the voice eigenvectors from the training data, each speaker in the training data is represented in voice eigenspace. In the case of speaker identification, each known speaker is represented in voice eigenspace as depicted at step 44. In the case of speaker verification, the group members and potential impostor speakers are represented in voice eigenspace as indicated at step 44. The group members may be represented in voice eigenspace either as points in eigenspace or as probability distributions in eigenspace, both of which may be referred to herein as eigenvoice vectors.

For each specific person, the eigenvoice vector from step 44 is stored in the main system memory 160. It is to be understood that any method that obtains eigenvoice vectors to identify individuals from their voice can be used in the practice of this invention.

Repeating, the prior art teaches that eigenface vectors generated from video images of the faces of members of a defined group of people can be used to identify a person of that group. Other prior art teaches that eigenvoice vectors generated from the voices of members of a defined group of people can be used to identify a person of that group. A more accurate and reliable identification of a person of a defined group of people can be obtained by using both eigenface vectors and eigenvoice vectors. This invention discloses a new improved method and apparatus for identifying individuals by using both eigenface vectors and eigenvoice vectors.

One method of using both eigenface vectors and eigenvoice vectors is to first use the eigenface vectors to identify a person. Then, the eigenvoice vectors are used to identify a person. Thereafter, the results are compared and a positive result is obtained when there is a match. This method requires two additional steps. Thus, if eigenface vectors are normally used to identify a person, then the additional step of using eigenvoice vectors, and the step of comparing the results are required. Another method may be to add the two vectors together to obtain a third or composite vector which is then used to identify a person. In the invention here disclosed, the data of the eigenface vector and the data of the eigenvoice vector are concatenated to obtain a composite eigenvector. Then, principle component analysis is performed on the composite eigenvector. This process saves a processing step and time. It is not that the vectors are added together, it is that the data of the eigenvoice and eigenface vectors are concatenated to obtain a totally new composite vector.

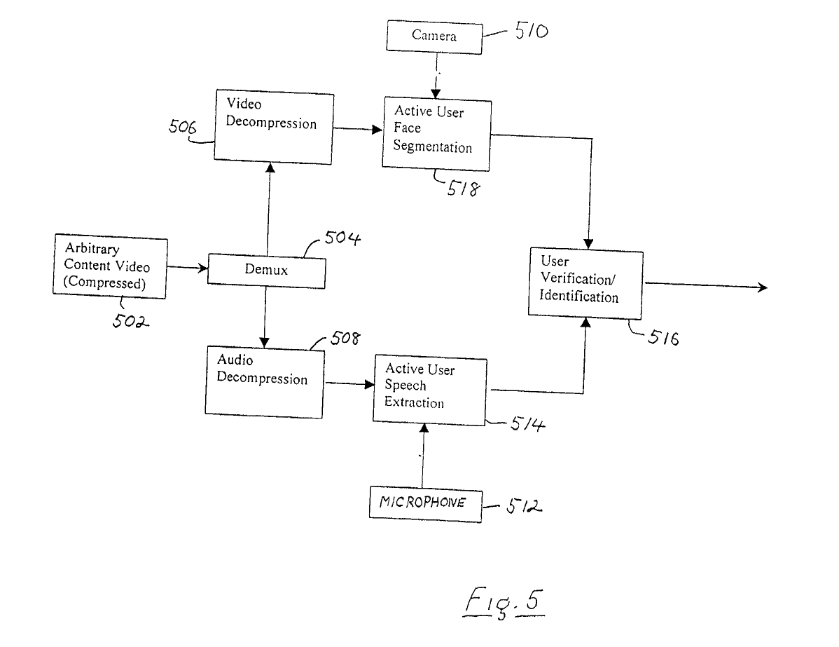

Referring now to FIG. 5, there is illustrated a block diagram of an audio-video person identification/verification system in accordance with the present invention. It is to be understood that the system can receive input signals from a variety of sources. For example, input signals for processing may be received from a real time source such as a video camera, or an archival source such as a tape, a CD, or the like. Arbitrary content video 502 is an input signal that may be received from either a live source or an archival source. Preferably, the system may accept, as arbitrary content video 502, video that is compressed in accordance with a video standard such as the Moving Picture Expert Group-2 (MPEG-2) standard. To meet this standard, the system includes a video demultiplexer 504 which separates compressed audio signal from compressed video signal. The video signal is then decompressed in video decompressor 506, while the audio signal is decompressed in audio decompressor 508. The decompression algorithms are standard MPEG-2 techniques and, therefore, will not be further described. If desired, other forms of compressed video may be processed in accordance with the present invention.

Alternatively, the system of the present invention is capable of receiving real time arbitrary content directly from a video camera 510 and microphone 512. While the video signals received from the camera 510, and the audio signals received from the microphone 512 are shown in FIG. 5 as not being compressed, the data may be compressed where appropriate. Consequently, a decompression mechanism would be required in accordance with the applied compression scheme.

The system shown in FIG. 5 includes an active user speech extraction module 514. The active user speech extraction module 514 receives an audio or speech signal and, as is known in the art, extracts spectral features from the signal. The spectral features are in the form of data of acoustic feature vectors which are then passed on to a user verification identification module 516. As previously noted, the audio signal may be received from the audio decompression module 508 or directly from the microphone 512, depending on the source of the audio. The extraction of the data of acoustic vectors (the eigenvoice vectors), is known in the art and explained in detail in U.S. Pat. No. 6,141,644. After the data of the acoustic feature vectors are obtained by the active user speech extraction module 514, they are forwarded to user verification/identification module 516.

Referring now to the video signal path of FIG. 5, there is included an active user face segmentation module 518. The active user face segmentation module 518 can receive video input signals from one or more sources, e.g., video decompression module 506, or camera 510. The active user face segmentation module 518 extracts spectral features from the signal. The spectral features are in the form of data of video feature vectors more specifically known as data of eigenface vectors which are then passed on to the user verification/identification module 516. The video signals may be received from the video decompression module 506, or directly from the camera 510, depending on the source of the video. The extraction of the data of the video vectors, the data of eigenface vectors, is well known in the art and is explained in detail in U.S. Pat. No. 5,710,833, the disclosure of which is incorporated by reference.

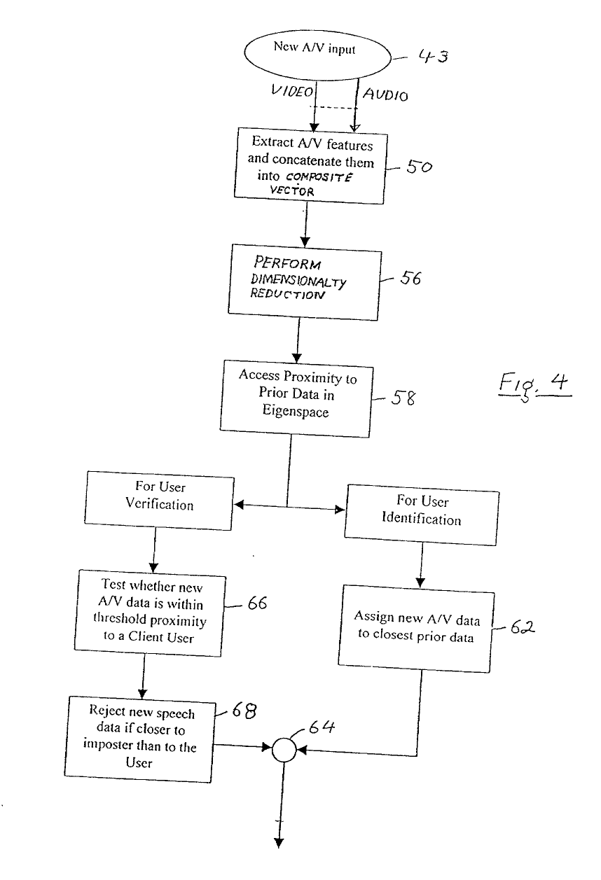

Referring now to FIG. 4, a user seeking video/audio identification/verification of a person supplies new video-audio data at 43 received from, for example, the camera 510 and the microphone 512. The audio/video information is then processed to provide data of the eigenvoice and eigenface vectors. The data of the eigenvoice and eigenface vectors are passed to the user verification/identification module 516, where the data are concatenated and processed using linear transformation such as principle component analysis to generate a composite vector (step 50). Dimensionality reduction is performed upon the composite vector which results in a new data point that can be represented in eigenspace (step 56). Having placed the new data point in eigenspace, the new data point may now be assessed with respect to its proximity to the data points, or data distributions corresponding to basic set of vectors obtained from the main memory (step 58).

For person identification, the composite vector of the new data is assigned to the closest composite eigen vector (step 62), and the result is directed to combiner 64. For verification of a person, the system compares the composite vector for the new data with the composite vectors stored in the main memory, step 66, to determine whether they are within a predetermined threshold proximity to each other in eigenspace. As a safeguard, the system may, at step 68, reject the new speaker data if it lies closer in eigenspace to an impostor than to the speaker. The signal from step 68 is directed to combiner 64, the output of which provides the desired answer of whether the new audio-video information is of a member of the designated group of people.

Thus, while there has been shown and described the fundamental novel features of the invention as applied to a preferred embodiment thereof, it is to be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, that this invention is to be limited only as indicated by the scope of the claims appended hereto.

What is claimed is:

1. A method of performing person recognition comprising the steps of:
obtaining data of a first eigenvector of a person;
obtaining data of a second eigenvector of the person;
concatenating the data of the first eigenvector with the data of the second eigenvector to obtain a composite eigenvector; and
performing person recognition using the obtained composite eigenvector.

2. The method of claim 1 further comprising the step of:
performing linear transformation on the obtained composite eigenvector.

3. The method of claim 2, wherein linear transformation is principle component analysis.

4. The method of claim 1, wherein the data of the first eigenvector is of an eigenvoice vector.

5. The method of claim 1, wherein the data of the second eigenvector is of an eigenface vector.

6. The method of claim 1, wherein the step of performing person recognition comprises comparing the composite eigenvector with an eigenvector of a select person to determine if there is a match.

7. The method of claim 6, wherein the eigenvector of the select person is a composite vector obtained by concatenating the data of at least two eigenvectors, one of which is an eigenvoice vector.

8. The method of claim 6, wherein the eigenvector of the select person is a composite vector obtained by concatenating the data of at least two eigenvectors, one of which is an eigenface vector.

9. The method of claim 6, wherein the eigenvector of a select person is at least a composite vector obtained by concatenating the data of at least two eigenvectors, one of which is data of an eigenvoice vector and the other of which is data of an eigenface vector.

10. The method of claim 2, wherein the step of performing person recognition comprises comparing the composite eigenvector with more than one eigenvector, each of which is for a discrete person, to determine if there is a match.

11. The method of claim 10, wherein the eigenvectors of each discrete person is obtained by concatenating the data of at least two eigenvectors, one of which is an eigenface vector.

12. The method of claim 10, wherein the eigenvectors of each discrete person are obtained by concatenating the data of at least two eigenvectors, one of which is an eigenvoice vector.

13. The method of claim 10, wherein the eigenvectors of each discrete person are obtained by concatenating the data of at least two eigenvectors, one of which is data of an eigenvoice vector and the other of which is data of an eigenface vector.

14. A method of performing person recognition comprising the steps of:
processing a video signal of at least one person of a select group of people to obtain data of a first eigenvector;
processing an audio signal of the at least one person of the select group of people to obtain data of a second eigenvector;
concatenating the data of the first eigenvector with the data of the second eigenvector to obtain a composite eigenvector; and
using the composite eigenvector to make a recognition decision about a person.

15. The method of claim 14, further comprising the step of:
processing a video signal of a person to be identified to obtain data of a fourth eigenvector;
processing an audio signal of the person to be identified to obtain data of a fifth eigenvector; and
concatenating the data of the fourth and fifth eigenvectors to obtain a sixth composite eigenvector; wherein the recognition decision is based on a comparison of the third and the sixth composite eigenvectors.

16. The method of claim 15, wherein:
the data of the fourth eigenvector is of an eigenface vector;
the data of the fifth eigenvector is of an eigenvoice vector; and
the sixth composite eigenvector is of a person to be identified as being of the select group of people.

17. An apparatus for determining person recognition comprising:
processor operable to process data of a first eigenvector of a person to be recognized and data of a second eigenvector of that person to obtain a composite eigenvector; and
means to compare the composite eigenvector with an eigenvector obtained from eigenvectors of a person of a select group of people to determine a level of correlation between the two.

18. The apparatus of claim 17, wherein the eigenvectors of a person of a select group comprises a composite eigenvector obtained by concatenating data of an eigenface vector and an eigenvoice vector.

19. The apparatus of claim 18, wherein for each person of the select group, there is a composite eigenvector obtained by concatenating data of an eigenface vector and an eigenvoice vector; and further comprising storage means coupled to the processor for storing the composite eigenvector obtained by concatenating data.
